(19) United States
(12) Patent Application Publication
(10) Pub. No.: US 2025/0282684 A1
(43) Pub. Date: Sep. 11, 2025

(54) CONCRETE FORMULATION FOR 3D PRINTING

(71) Applicant: Board of Regents for the Oklahoma Agricultural and Mechanical Colleges, Stillwater, OK (US)

(72) Inventors: Matthew Tyler Ley, Stillwater, OK (US); Masoud Forsat, Stillwater, OK (US)

(21) Appl. No.: 19/073,545

(22) Filed: Mar. 7, 2025

Related U.S. Application Data
(60) Provisional application No. 63/562,365, filed on Mar. 7, 2024.

(51) Int. Cl. C04B 28/04; B28B 1/00; B33Y 10/00; B33Y 70/00; C04B 14/06; C04B 22/00; C04B 24/06; C04B 103/00; C04B 103/30; C04B 111/00

(52) U.S. Cl. CPC C04B 28/04; B33Y 70/00; C04B 14/06; C04B 22/0093; C04B 24/06; B28B 1/001; B33Y 10/00; C04B 2103/0039; C04B 2103/0085; C04B 2103/302; C04B 2111/00181

(57) ABSTRACT

Concrete formulation for 3D printing which results in improved structural integrity of concrete members printed from the formulation.

### CROSS-REFERENCE TO RELATED APPLICATIONS

This application claims priority to U.S. Provisional Application No. 63/562,365, filed Mar. 7, 2024, the entirety of which including the Appendix thereto is incorporated into this application by reference.

### BACKGROUND

Most known concrete formulations require forms to be placed, which is not conducive to 3D printing methods. Embodiments of the following disclosure address this need in the art.

### SUMMARY

One embodiment of the disclosed concrete formulation comprises: (a) a hydraulic component having a cementitious base material comprising a source of aluminum and a source of calcium; (b) an aggregate component comprising: (i) coarse aggregates having a nominal maximum aggregate size of greater than 12.5 mm; (ii) optionally, intermediate aggregates having a nominal maximum aggregate size of 4.75-12.5 mm; and (iii) fine sand aggregates having a nominal maximum aggregate size of 4.75 mm or less; (c) an admixture component comprising: (i) sticky additive; (ii) optionally, a weak acid; and (iii) optionally, a water reducer.

Also disclosed are methods of 3D printing the described concrete formulations, as well as concrete members and structures prepared by the 3D printing methods.

### BRIEF DESCRIPTION OF THE DRAWINGS

The foregoing summary, as well as the following description of the disclosure, is better understood when read in conjunction with the appended drawings. For the purpose of illustrating the disclosure, the drawings illustrate some, but not all, alternative embodiments. This disclosure is not limited to the precise arrangements and instrumentalities shown. The following figures, which are incorporated into and constitute part of the specification, assist in explaining the principles of the disclosure.

FIG. 1A is a photograph of coarse aggregate used in the Examples.

FIG. 1B is a photograph of intermediate aggregate used in the Examples.

FIG. 1C is a photograph of fine aggregate used in the Examples.

FIG. 2 shows a plot of aggregate gradation for the coarse, intermediate, and fine aggregate used in the Examples.

FIG. 3 shows plots of particle size distribution (rod length) of the nanoclay used in the Examples.

FIG. 4 shows a plot of Tarantula curve limits for slip formed pavements.

FIG. 5A is a photograph of a 3D-printed concrete wall with an “excellent” visual ranking as described in Table 4.

FIG. 5B is a photograph of a 3D-printed concrete wall with a “good” visual ranking as described in Table 4.

FIG. 5C is a photograph of a 3D-printed concrete wall with a “poor” visual ranking as described in Table 4.

FIG. 5D is a photograph of a 3D-printed concrete wall with an “unacceptable” visual ranking as described in Table 4.

FIG. 6 is a photograph showing three areas of a 3D-printed concrete wall, with cohesiveness and surface quality of the three areas described in Table 5.

FIG. 7 shows Tarantula curve plots for exemplary mixes at different water-to-cement (w/c) ratios.

FIG. 8 is a graph of visual ranking versus w/c ratio and water reducer used in the Examples.

FIG. 9 shows a plot of fine sand (FS) content on the Tarantula curve.

FIG. 10 shows Tarantula curve plots for exemplary mixes with different fine sand (FS) contents.

FIG. 11 shows a plot of the fine sand (FS) content versus the visual rating for exemplary mixes.

FIG. 12 shows Tarantula curves of an exemplary mix with different nanoclay percentages.

FIG. 13 shows a plot of nanoclay percentage vs print quality for different exemplary mixes. Percentages on each data point are: “Nanoclay %, Citric acid %.”

FIG. 14 shows a graph of change in Oopsie vs visual ranking for exemplary mixes.

FIG. 15 shows a plot of find sand content (%) compared to the performance of exemplary concrete formulations in the Oopsie test at different biopolymer dosages. The biopolymer used was a polysaccharide (diutan gum) of the concrete formulation. The horizontal dotted line indicates the 0.5 inch limit of the Oopsie test. Above the horizontal dotted line represents unacceptable slacking.

FIG. 16 shows the a plot of the surface rating of a 3D printed wall for a fine sand content of 38% and different dosages of nanoclay. All mixtures used 38% fine sand content.

FIG. 17 shows a plot of surface rating in a 3D printed wall versus fine sand content at different biopolymer dosages in the concrete formulation used to form the wall. The biopolymer used was a polysaccharide.

FIG. 18 shows a plot of surface rating versus fine sand content (%) in a 3D printed wall formed from a concrete formulation having a nanoclay dosage of 27.5 oz/cwt. The nanoclay dosage was 27.5 oz/cwt.

FIG. 19 shows a plot of edge slump (in) versus biopolymer dosage (oz/cwt) for a 3D printed wall formed from a concrete formulation having a fine sand content between 26% and 48% per hundred lbs. of the hydraulic component of the concrete formulation. This plot represents a quantitative measure of performance. The error bars show one standard deviation.

### DETAILED DESCRIPTION

### I. Concrete Formulation

### A. Hydraulic Component

The concrete formulation generally comprises a hydraulic component. In one embodiment, the hydraulic component includes a cementitious base material comprising a source of aluminum and a source of calcium. Within this category are a Portland cement, calcium sulfoaluminate cement, a geopolymer, a calcium aluminate cement, a Portland limestone cement, or a blended Portland cement, among others.

Portland cement is a common form of hydraulic cementitious material. “Cement” is a general term used to describe a material comprising organic and inorganic binding agents. Hydraulic cements are materials which set and harden after combining with water as a result of chemical reactions during mixing. These cements retain strength and stability after hardening upon exposure to water. Examples of Portland cement blends include Portland blast-furnace slag cement, Portland-fly ash cement, Portland pozzolan cement, Portland silica fume cement, masonry cement, and expansive cement.

With respect to certain embodiments of the base cementitious material, the following cement chemist notations (CCNs) may be used in this application for convenience.

| CCN | Formula | Name | Mineral Phase |
|---|---|---|---|
| C₂S | 2 CaO•SiO₂ | Dicalcium silicate | Belite |
| C₃S | 3 CaO•SiO₂ | Tricalcium silicate | Alite |
| C₃A | 3 CaO•Al₂O₃ | Tricalcium aluminate | Aluminate or |
| | | | Celite |
| C₄AF | 4 CaO•Al₂O₃•Fe₂O₃ | Tetracalcium alumino | Ferrite |
| | | ferrite | |

The composition of Portland cements can vary significantly. Several classes of Portland cement have been described in ASTM C150 and European standard EN 197. Typical Portland cements have a composition of 45-75% C3S, 7-32% C2S, 0-13% C3A, 0-18% C4AF and 2-10% gypsum on a w/w basis. The main classes of Portland cement as described in ASTM C150 are Types 1-V. Type I Portland cement is a general-purpose cement and is the most common. Type I cements have a typical composition of 55% C3S, 19% C2S, 10% C3A, 7% C4AF, 2.8% MgO, 2.9% S, with 1% ignition loss and 1% free CaO on a w/w basis.

Type II Portland cement releases less heat compared to Type I Portland cement and requires that the amount of C3A does not exceed 8% on w/w basis. A typical composition of a Type II Portland cement is 51% C3S, 24% C2S, 6% C3A, 11% C4AF, 2.9% MgO, 2.5% S, with 0.8% ignition loss and 1% free CaO on a w/w basis. Type III Portland cement has a relatively high early strength and has particle sizes finer than Type I Portland cement. Type III Portland cement typically has a specific surface area of 50-80% higher than Type I Portland cement. Additionally, a Type III Portland cement has a 3-day compressive strength equal to the 7-day compressive strength of a Type I and II Portland cement and a Type III cement has a 7 day compressive strength equal to the 28-day compressive strength of a Type I and II Portland cement. A typical composition of a Type III Portland cement is 57% C3S, 19% C2S, 10% C3A, 7% C4AF, 3.0% MgO, 3.1% S, with 0.9% ignition loss and 1.3% free CaO on a w/w basis.

Types la, lla and Ilia are variants to Types l-lll Portland cements and refers to the addition of an air-entraining agent which is ground into the composition. Further, Types ll(MH) and ll(MH) A have a similar composition to Type II Portland cement above, however has mild heat release. According to European standard EN 197, five classes of Portland cement have been described which are different to the classes described in ASTM C150 and ASTM C595. EN 197 describes Type I Portland cement as Portland cement comprising Portland cement and up to 5% of minor additional constituents; Type II Portland-composite cement comprises Portland cement and up to 35% of other single constituents; Type III Blast furnace cement comprises Portland cement and higher percentages of blast furnace slag; Type IV Pozzolanic cement comprises Portland cement and up to 55% of pozzolanic constituents; and Type V Composite cement comprising Portland cement, pozzolan and blast furnace slag or fly ash. ASTM Type IL Limestone cement, as outlined in ASTM C595, is also a suitable type of Portland cement. Any of these types of Portland cement or other cements described above can be used in the formulation.

In some embodiments, the hydraulic component further comprises a supplementary cementitious material. The supplementary cementitious component can be any suitable material such as fly ash, slag, silica fume, metakaolin, ground glass, natural pozzolans, manufactured pozzolans, pozzolanic materials, lime, mortar, ground granulated blast furnace slag, calcined clay, calcined shale, refractory cements, gypsum, expanding cements, sand, rice hull ash, quartz, silica, amorphous silicon dioxide, cement asbestos board (CAB), calcium aluminate cement, or the like.

### B. Aggregate Component

The aggregate component generally comprises (i) coarse aggregates having a nominal maximum aggregate size of greater than 12.5 mm; (ii) optionally, intermediate aggregates having a nomimal maximum aggregate size of 4.75-12.5 mm; and (iii) fine sand aggregates having nomimal maximum size of 4.75 mm or less, e.g., 0.075 mm-4.75 mm. In some aspects, the aggregate component includes intermediate aggregates, and in some aspects, it does not. In general, the need for intermediate aggregates can depend on the gradation of the coarse aggregates.

“Nominal maximum aggregate size” refers to the ASTM E11 test sieve size that retains some of the aggregate but not more than 10%. ASTM E11 test sieve sizes in standard and US units are shown in the table below.

| | |
|---|---|
| Standard | US Alternative |

| | | | | |
|---|---|---|---|---|
| Coarse Series | 100.0 | mm | 4 | inches |
| | 90.0 | mm | 3.5 | inches |
| | 75.0 | mm | 3 | inches |
| | 63.0 | mm | 2.5 | inches |
| | 50.0 | mm | 2 | inches |
| | 37.5 | mm | 1.5 | inches |
| | 25.0 | mm | 1 | inch |
| | 19.0 | mm | 0.75 | inches |
| | 12.5 | mm | 0.5 | inches |
| | 9.5 | mm | 0.375 | inches |

| | | | |
|---|---|---|---|
| | 4.75 | mm | No. 4 |
| Fine Series | 2.36 | mm | No. 8 |
| | 1.18 | mm | No. 16 |
| | 600 | μm | No. 30 |
| | 300 | μm | No. 50 |
| | 150 | μm | No. 100 |
| | 75 | μm | No. 200 |

Nomimal maximum fine sand size can be obtained from a sieve analysis (ASTM C136-06, and in some aspects in combination with ASTM C 117 for material finer than 75 μm sieve). Fine sand content is defined as the material retained on the #30, #50, #100, and #200 sieve. In some embodiments, the formulation comprises at least 30% fine sand aggregates by volume of the aggregate component.

Any suitable aggregate can be used in the formulation. In certain embodiments, the aggregate is an inert granular material. In some examples, one or more of the aggregates is sand, gravel, crushed stone, slag, recycled concrete, or any combination thereof.

### C. Admixture Component

In general, the admixture component includes (i) sticky additive; (ii) optionally, a weak acid; and (iii) optionally, a water reducer or a combination of water reducers. In some aspects, the admixture includes the weak acid, the water reducer, or both, and in some aspects, the admixture does not include either of the weak acid or the water reducer. In a further aspect, the admixture component includes one of but not both of the weak acid or the water reducer (e.g., the admixture can include the weak acid and not the water reducer, or the admixture can include the water reducer and not the weak acid).

i. Sticky Additive

The “sticky additive” in the concrete formulation is a viscosity modifier which enhances the stability and cohesion of the concrete and ensures high resistance to water dilution and bleeding. In some aspects, the sticky additive creates flexible particles that stick to one another, or creates a structure in the concrete which has low tensile strength. The sticky additive can also impart shear thinning properties to the concrete formulation, where apparent viscosity decreases or increases in response to application or removal of shear force. In the case of certain biopolymers, for instance, which are described more below, this shear thinning property may be due to long chain chemical structures, which, at low shear rates, intertwine and entangle to increase viscosity and, at high shear rates, align along the flow direction and act as lubricant to lower viscosity. Similar effects may be observed when using a nanoclay as the sticky additive.

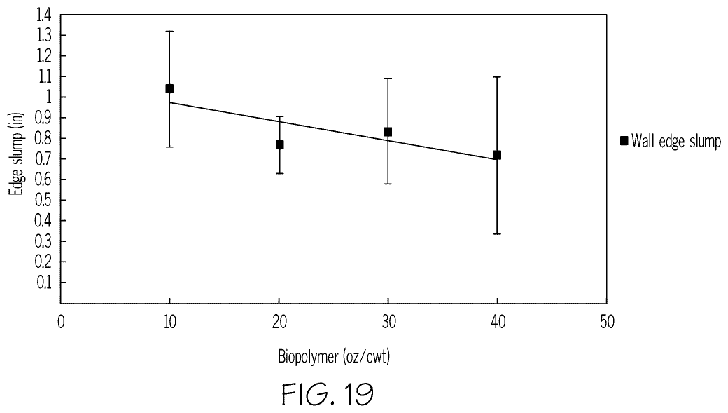

The effectiveness of sticky additives can be measured by their ability to hold the shape of the wet or fresh concrete. This allows the concrete to hold an edge after being placed. One application is in 3D printing. One way to measure the effectiveness of sticky additives is by 3D printing a concrete wall and then measuring the deformation without forms. This is referred to as the edge slump of the concrete. FIG. 19 shows the impact of different dosage of a diutan gum (a biopolymer, saccharide, sticky additive) on the edge slumping of a 3D printed wall. The average is shown along with error bars showing the standard deviation. The figure shows a reduction in the edge slumping from an increase in the dosage of sticky additive.

Edge slump can also be measured by filling a wooden form with an open top and bottom and then removing the forms and measuring the edge slump from the self weight. It is also possible to measure the effectiveness of the sticky additive by creating a shape of fresh concrete with a known dimension such as a cylinder or a prism, and then loading that shape and measuring the deformation. This can be done with the Oopsie test, described in more detail below. The dosage of the sticky additive will change how the wet concrete deforms to weight.

In some aspects, due to the presence of the sticky additive, a 3D printed structure formed from the disclosed concrete formulation exhibits an edge slump as measured according to the Oopsie test of 1.4 inches or less, 1.3 inches or less, 1.2 inches or less, or 1.1 inches or less, including for example, between and including 1.4 inches and 0.5 inches, 1.3-0.6 inches, 1.2-0.7 inches, or 1.1-0.7 inches. Based on correlations between edge slump in the 3D printed wall and performance in the Oopsie test, mixtures may have a change in width of less than 0.5 inches when 13.2 lbs of weight are placed on the surface of a 3D printed structure formed from the concrete formulation. In some aspects, as the sticky additive is increased then the amount of edge slumping can decrease. Similarly, in some aspects, as the fine sand content is increased edge slumping can also decrease. This decrease in edge slumping should to be balanced with the surface finish of the wall that is measured in the surface ratings.

Some sticky additives are used in concrete to increase the cohesion of the mixture but are not used at the high dosage of the sticky additives as described in certain aspects of this disclosure. For example, the sticky additives used in some aspects of the disclosed concrete formulations are 3× to 20× higher than that used in conventional concrete mixtures.

The performance of the sticky additive may also depend on the amount of fine sand used in the formulation. Fine sand can change the packing of the concrete, which in turn changes the amount of load transferred in the concrete. The sticky additive also may interact with these fine sand particles and thus certain size distributions may change the cohesion more than others.

Another parameter is the role of water reducers with sticky additives. Water reducers disperse cement grains without adding additional water to the concrete. The water reducers make it easier for the concrete to flow so that less work is needed to 3D print and consolidate the concrete; however, additional sticky additive may be needed to maintain the cohesion of the mixture. At some point, the sticky additive may not be able to overcome the water reducer, and the concrete will not stand on it own. To overcome this, the amount of water reducer can be selected based on the methods explained in this disclosure. Water reducer amount can also be optimized by the box tests (edge slump) and the Oopsie test described elsewhere.

In some embodiments, the concrete formulation can comprise 10-50 ounces of sticky additive per hundred lbs. of the hydraulic component. In a further embodiment, the sticky additive in the mixture can be combined with a viscosity modifying agent or a gum or any other type of sticky additive. In one aspect, the sticky additive is a nanoclay or a biopolymer. A variety of nanoclays can be used. In some aspects, the nanoclay is derived from layer silicates (such as kaolinite, allophane, montmorillonite, nontonite, beidellite, halloysite, smectite, vermiculite, mica, or illite), chain silicates (such as palygorskite, attapulgite, or sepiolite) sesquioxides (crystalline metal oxides or metal hydroxides or amorphous metal oxides, metal hydroxides, allophane, or imogolite) or other carbonate and sulfate based clays. The chart below shows non-limiting examples of suitable materials from which the nanoclay can be derived. See Kumari, N., & Mohan, C. (2021). Basics of Clay Minerals and Their Characteristic Properties.

Another suitable nanoclay is made of purified magnesium aluminosilicate particles, which are chemically exfoliated from bulk attapulgite to remove high water demand impurities such as bentonite and other swelling clays. The clay mineral has a 2:1 layer, fibrous structure, and it contains various hydroxyl groups (such as Al—OH and Mg—OH), with oxygen ions on the tetrahedral sheet, water molecules coordinated to Mg ions at the edges or ends of the fibers, and Si—OH groups along the fiber axis. Due to its unique fibrous structure and high specific surface area, attapulgite can retain water up to 200% of its own weight. Under shearing, the nanoclay particles break down into needle-like structures with an average length of 1.75 μm, an average diameter of 30 nm, and specific surface area of 150 m²/g (compared to 0.3-0.4 m²/g for ordinary Portland cement). In some embodiments, the nanoclay has an average particle diameter of 10-100 nm. The nanoclay can be present in the formulation in a variety of suitable amounts.

In a further aspect, the sticky additive comprises a biopolymer, a composition that includes a biopolymer, or a substance derived therefrom. Examples include proteins, such as collagen, actin, and fibrin. Other examples include polyhydroxyalkanoates (PHAs), which are commonly found in microorganisms and genetically modified organisms. Biopolymers such as polylactic acid (PLA), polyglycolic acid (PLGA), and polycaprolactone can also be used as the sticky additive.

In one aspect, the biopolymer is a polysaccharide. These include welan gum, xanthan gum, diutan gum, cellulose ethers in general, starch, starch-based gums, and chitosan. Both welan gum and diutan gum are bacterial extracellular polysaccharides produced in aerobic fermentation. Cellulose ethers are derived from cellulose, the major components of plant cell walls. Specific non-limiting examples of cellulose ethers include methyl cellulose and hydroxypropyl cellulose. Chitosan is the major component of the exoskeleton of crustaceans (such as crabs and shrimp) and cell walls of fungi. Other examples of suitable polysaccharides include alginate, exopolysaccharides, microbial polysaccharides, marine gums, plant exudates, and seed gums. Likewise, compositions that includes one or more biopolymers can be used as the sticky additive, including for example, bacterial cell walls, bacterial peptidoglycans, and other biopolymers such as biopolymer S-657.

ii. Optional Weak Acid

A variety of inorganic and organic weak acids can be used. Examples include formic acid, acetic acid, benzoic acid, phosphoric acid, sulfurous acid, citric acid, or a combination thereof. In some aspects, the formulation can include 0.1-0.5% of the weak acid by weight of the hydraulic component. In a further aspect, the mass weight ratio of the weak acid to nanoclay is 1:5 to 1:15 (weak acid: nanoclay), including for example 1:5 to 1:12, 1:5 to 1:10, 1:5 to 1:8, 1:5 to 1:7, or 1:5 to 1:6. In some aspects, the concrete formulation includes the weak acid, and in some aspects, it does not.

iii. Optional Water Reducer

The optional water reducer can be any suitable water reducer. Examples include lignin based water reducers. Other water reducers such as polycarboxylates, naphalene based water reducers or other suitable products can be used. When the water reducer is used, the formulation can comprise 1-25 ounces of the water reducer per hundred lbs. of the sum of the hydraulic and aggregate components. Blends of water reducers may also be used. In some aspects, the concrete formulation includes the water reducer, and in some aspects, it does not.

### II. 3D Printing Methods

The described concrete formulation is particularly suitable for 3D printing concrete. In one aspect, the disclosed printing method comprises (a) positioning a plurality of reinforcement members in a travel path of a concrete member creating device; (b) moving the concrete member creating device along the travel path past the plurality of reinforcement members; (c) delivering a first cementitious mixture into a space defined by the concrete member creating device through a side of the concrete member creating device as the concrete member creating device moves along the travel path, wherein the first cementitious mixture is formed from water and any suitable concrete formulation described above; and (d) pressurizing the first cementitious mixture within the concrete member creating device as the concrete member creating device is moved to create a first layer of the concrete member.

In some instances the method may further comprise (a) lifting the concrete member creating device after the concrete member creating device has traveled a desired distance along the travel path to create the first layer of the concrete member; (b) returning the concrete member creating device to a desired location along the travel path; and (c) moving the concrete member creating device above the first layer of the concrete member and along the travel path past the plurality of reinforcement members; (d) delivering a second cementitious mixture into a space defined by the concrete member creating device through a side of the concrete member creating device as the concrete member creating device moves along the travel path, wherein the second cementitious mixture is formed from water and any suitable concrete formulation described above; and (d) pressurizing the second cementitious mixture within the concrete member creating device as the concrete member creating device is moved above the first layer of the concrete member to create a second layer of the concrete member atop the first layer of the concrete member.

In a further aspect, the method further comprises (a) lifting the concrete member creating device after the concrete member creating device has traveled the desired distance along the travel path to create the second layer of the concrete member; (b) returning the concrete member creating device to a desired location along the travel path; and (c) repeating the moving the concrete member creating device step, the delivering step, the pressurizing step, the lifting step, and the returning step above the second layer of the concrete member a desired number of times to create additional layers of the concrete member atop the first and second layers until the concrete member has reached a desired height.

In some aspects of the method, the concrete member creating device comprises: (a) a first side plate through which the cementitious mix is delivered; and (b) a second plate spaced from the first side plate. In one embodiment, the method comprises moving the first and second plates with a single transport unit. For example, the method can comprise moving the first and second side plates in a synchronous manner with first and second transport units respectively. In general, for the printing methods, the ratio of water to the concrete formulation can be 0.35-0.5. The printing method can also be performed with the disclosed concrete formulations, as used with the devices and methods described in PCT/US2023/033364, filed Sep. 21, 2023, and published as WO/2024/064272, the entirety of which is incorporated into this application by reference in its entirety and which is also attached to this application's priority document as Appendix A and thus a part of the present specification.

### EXAMPLES

The following examples further illustrate this disclosure. The scope of the disclosure and claims is not limited by the scope of the following examples.

### I. Materials

### A. Cementitious Materials

Concrete is a mix of aggregates, cementitious materials, water, and optional admixtures. ASTM Type IL Limestone cement, as outlined in ASTM C595, was utilized as the primary binder to make the concrete. Additionally, a Class C fly ash (FA), meeting the ASTM C618 for supplementary cementitious materials (SCM), was included. The specifications for these cementitious materials are shown in Table 1. Limestone may be natural or synthetic.

TABLE 1

| | Portland Limestone Cement | Class C Fly Ash |
|---|---|---|
| Component | (mass %) | (mass %) |
| SiO₂ | 21.1 | 17.0 |
| CaO | 62.1 | 41.0 |
| Al₂O₃ | 4.7 | 17.2 |
| MgO | 2.4 | 10.3 |
| Fe₂O₃ | 2.6 | 7.4 |
| SO₃ | 3.2 | 2.4 |
| K₂O | 0.3 | 0.2 |
| Na₂O | 0.2 | 1.1 |

Cement Chemist Notation (CCN)

| | | |
|---|---|---|
| C₂S | 17.8 | — |
| C₃S | 56.7 | — |
| C₃A | 8.2 | — |
| C₄AF | 7.8 | — |

### B. Aggregates

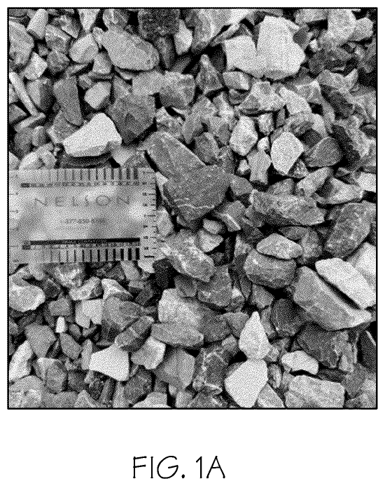

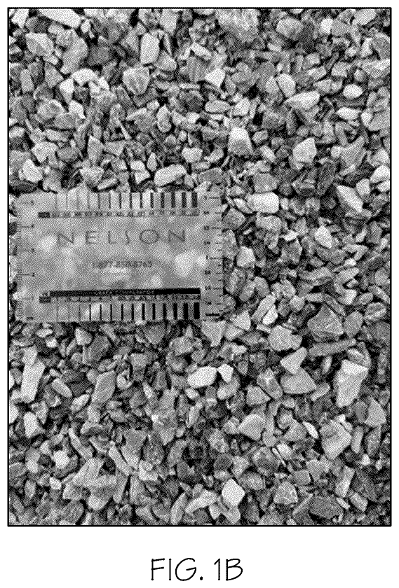

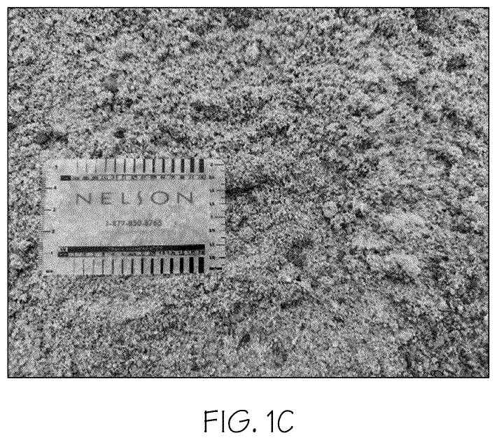

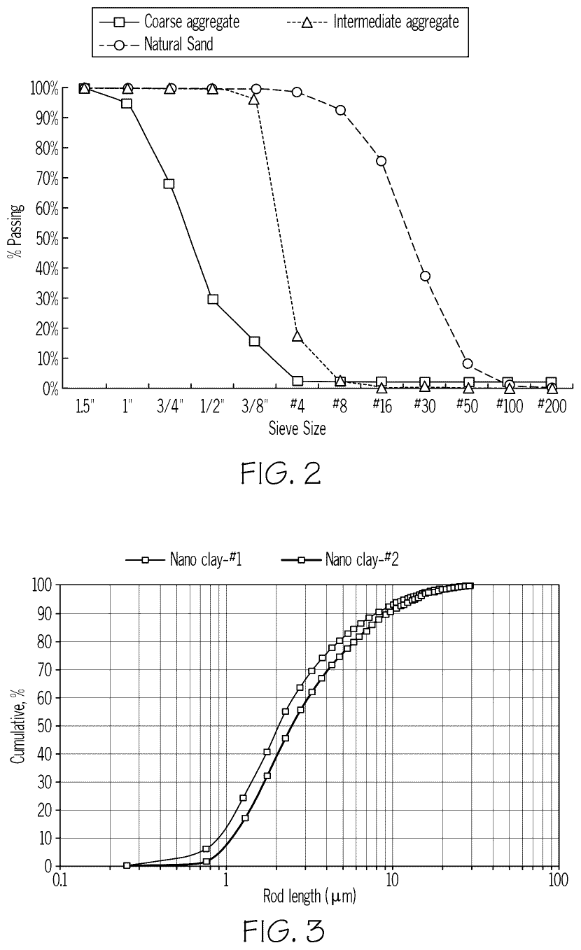

All aggregates used are based on ASTM C33 standards, with a nominal maximum size of 19 mm (0.75 inches), and 9.5 mm (⅜ inches) for the coarse aggregates and intermediate aggregates, respectively (FIGS. 1A-B). Both the coarse and intermediate aggregates were obtained from the same dolomitic limestone quarry. The natural sand was used as the fine aggregate, meeting the requirement of ASTM C33 (FIG. 1C). The aggregates gradation plot is shown in FIG. 2, and the specific gravity and absorption specifications can be seen in Table 2.

TABLE 2

| | Coarse | Intermediate | |
|---|---|---|---|
| Properties | Aggregate | Aggregate | Natural Sand |
| Specific Gravity | 2.75 | 2.72 | 2.61 |
| Absorption (%) | 0.66 | 0.66 | 0.55 |
| Fineness Modulus | — | — | 2.68 |
| Nominal size (mm) | 19 | 9.5 | — |

### C. Sticky Additive

The sticky additive used in this examples was a nanoclay, specifically a magnesium aluminosilicate which was used as an admixture. The material was purified so that the remaining particles are rod-shaped. These materials are produced through a chemical exfoliating process. The process creates rod shaped particles that are positively charged on the ends and negatively charged along the axis. The nanoclay rods have an average particle length of 1.5 to 2 μm and an average diameter of 30 nm.

Because of the shape and charge of the nanoclay particles, they form a structure in the concrete that changes the way the cement and supplementary cementitious materials pack. This makes the resulting mixture more cohesive and increases the thixotropy of the mixture. If energy is added to a mixture with nanoclay, then the structure breaks down and the material will flow and be easier to pump or move with an auger. Once the mixture sits statically, the cement and supplementary cementitious materials start to settle and the rod shaped nanoparticles will change the way the materials pack and help the mixture retain its shape.

This process is reversible without seeing any impact on the change in the thixotropy of the concrete mixture. The surface charge on these nanoclay particles also impacts the effectiveness of other admixtures that are commonly used in concrete such as water reducing admixtures. Also, the surface charge makes the particles less predictable and more susceptible to changes in temperature, different cements, and supplementary cementitious materials or other chemicals. These challenges were overcome by functionalizing the surface of the nanoclay by using a weak acid such as citric acid. The particle distribution of the nanoclay is shown in FIG. 3 as measured by automated scanning electron microscopy.

### D. Citric Acid

The hydration of Portland cement or its components is slowed down by the presence of citric acid. The citric acid will slow the hydration reaction of the cement and supplementary cementitious materials and this will give more time to finish and consolidate the concrete. The chemical and physical properties of the used citric acid (CARECITRIC) in this study are shown in Table 3.

TABLE 3

| Parameter | Value | Tolerance | Unit |
|---|---|---|---|
| Assay (on dry basis) | 99.5 | ±0.5 | % |
| Moisture | 0.5 | Max | % |
| Sulphate (SO₄) | 150 | Max | ppm |
| Sulphated Ash | 0.05 | Max | % |
| Oxalates | 100 | Max | ppm |
| Bacterial Endotoxins | 0.5 | Max | I.U./mg |
| Arsenic | 1 | Max | ppm |
| Aluminum | 0.2 | Max | ppm |
| Heavy Metals as lead | 0.5 | Max | % |
| Particle size: Retained on 30 mesh | 5 | Max | % |
| Particle size: Retained on 80 mesh | 5 | Max | % |

The citric acid is used to modify the surface charge of the nanoclay. This causes the nanoclay to not absorb water reducers, and for the nanoclay performance to not be as susceptible to temperature or the type of cement and supplementary cementitious material that is used. Other weak acids can be used for these purposes.

The dosage rate for citric acid was typically 0.25% by weight of the cementitious materials. The dosage of nanoclay was typically 27.5 oz/hundred weight of cementitious material. The ratio of citric acid to nanoclay was 11.25% by mass. After adding all other ingredients, these two admixtures are added together to the mixer. These materials are not mixed prior to adding to the mixer.

### E. Water Reducer

The water reducer used was a lignin based water reducer. However, this is only an example as other water reducers such as polycarboxylates, naphthalene based or other suitable products or blends of products could be used.

### II. Methods

### A. Mixing Procedure

Aggregates were collected from outside storage piles and brought into a temperature controlled room at 73° F. for at least 24 h before mixing. Aggregates were placed in the mixer and spun, and a representative sample was taken for a moisture correction. At the time of mixing all aggregate was loaded into the mixer along with approximately two-thirds of the mixing water. This combination was mixed for three min to allow the aggregates to approach the saturated surface dry (SSD) condition and ensure that the aggregates were evenly distributed.

Next, the cement, fly ash, and the remaining water was added and mixed for three min. The resulting mixture rested for two min while the sides of the mixing drum were scraped. After the rest period, the water reducer, citric acid, and nanoclay can be added to the mixture, and the concrete was mixed for three min.

The concrete was tested for slump (ASTM C 143), unit weight (ASTM C 138), air volume (ASTM C 231), and 4″×8″ cylinders were taken to measure compression strength (ASTM C 39).

### B. Quantifying Aggregate Gradation

One part of a concrete mixture is the design of the aggregate gradation. Aggregates make up roughly 75% of the volume of a concrete mixture. Understanding how these materials perform is useful to any concrete mixture and this is especially useful to a concrete mixture that is 3D printed.

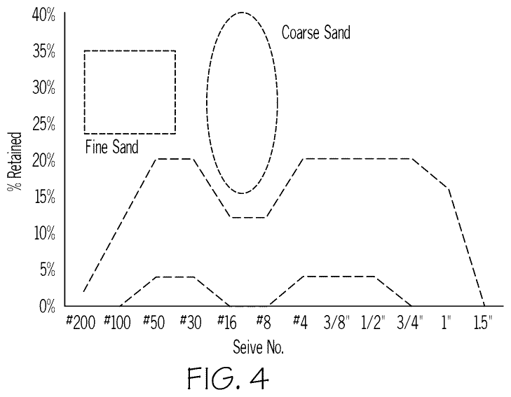

The most recent advancement in combined aggregate gradations is the Tarantula Curve. This plotting tool is shown in FIG. 4. The Tarantula Curve has three components: limits for the % retained on individual sieves, coarse sand content, and fine sand content. The combined gradation should be within the maximum and minimal values for the individual sieve limits. The fine sand content (sum of the #30, #50, #100, and #200) must be within a given range for finishing, cohesion, and consolidation, and the coarse sand content (sum of the #8, #16, and #30) must be above a limit to ensure proper cohesion of a concrete mixture.

### C. 3-D Printing Trial

The materials mentioned above were used to 3-D print walls that were 5′ long. Each mixture was placed in a 8″ high by 8″ wide lift with the printer. This print was then inspected in several different ways. The printing method is described in PCT/US2023/033364, filed Sep. 21, 2023, the entirety of which is attached to this application as Appendix A. Appendix A is intended to be part of the specification of the present application.

To assess print quality, four distinct categories served as reference points for ranking (Table 4 and associated Figures). The ranking is based on the evaluation of two parameters: (1) Concrete Cohesiveness: This parameter assesses whether the concrete is prone to segregation or has experienced failure from falling; and (2) Surface Texture: Under this parameter, factors like smoothness, surface quality, and the presence of bubbles or voids on the surface were considered.

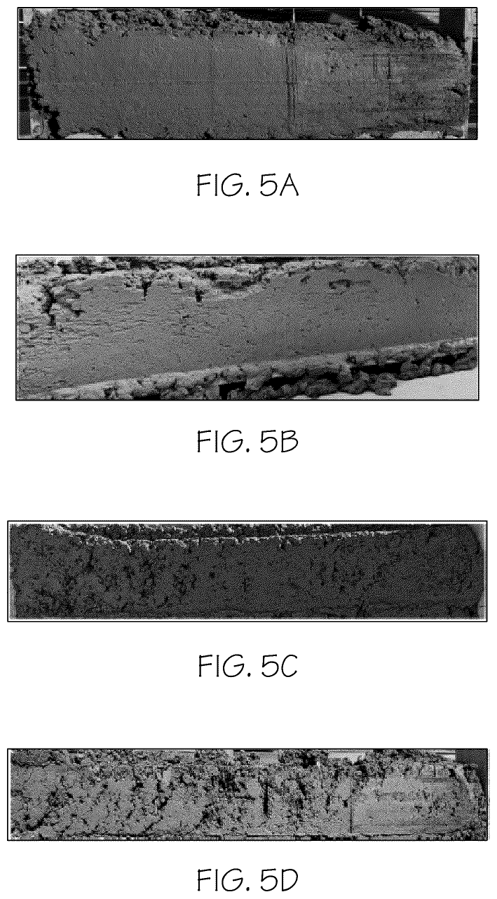

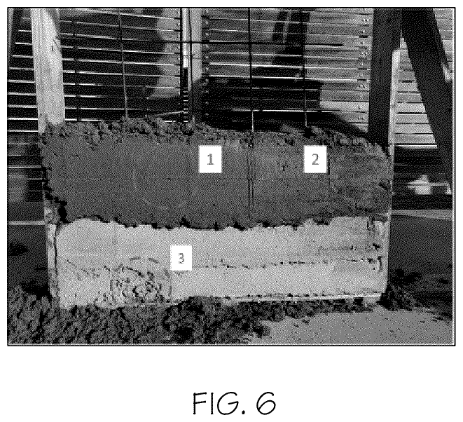

TABLE 4

| Visual | | |
|---|---|---|
| Ranking | Description | Photo |
| Excellent | The printed layer has less than 10% voids on | FIG. 5A |
| | the surface. | |
| Good | The printed layer has 10% to 30% voids on | FIG. 5B |
| | the surface. | |
| Poor | The printed layer has 30% to 50% voids on | FIG. 5C |
| | the surface. | |
| Unacceptable | The printed layer has more than 50% voids or it | FIG. 5D |
| | is segregated or failed by falling. | |

Table 5 indicates an example of the cohesiveness and print quality of a printed wall. Based on this table, the following can be concluded:

Area 1: the concrete is cohesive in this section. Also, the surface of the concrete has good quality. Good quality on the surface indicates it does not need additional hand finishing.

Area 2: the concrete is cohesive; however, the surface does not provide a good quality. Therefore, the mix is good but more surface treatment is needed such as with a hand trowel.

Area 3: The concrete does not have enough cohesion and consistency. The most common reason is the mixture design has issues. In some cases, the concrete cannot hold its shape, or the concrete may become segregated. These areas are challenging to repair by hand finishing and should be avoided.

TABLE 5
(See Areas on FIG. 6)

| | Cohesiveness | Surface quality |
|---|---|---|
| Area 1 | Acceptable | Acceptable |
| Area 2 | Acceptable | Reject |
| Area 3 | Reject | Reject |

### III. Results

The following different parameters were studied: (1) effect of water to cement ratio; (2) effect of fine sand; and (3) effect of nanoclay and citric acid. For each parameter, different mixtures were made and printed in a 5 feet wall. Each layer is 8″ tall and 8″ wide. The surface quality and the concrete cohesiveness were observed for each mix after print.

### A. Water to Cement Ratio

Various water-to-cement (w/c) ratios were investigated through systematic adjustments to the cementitious content within the mixture. The representation of this content can be articulated in terms of sack content, a metric derived by calculating the total cementitious materials divided by 94 lbs., representing the standard weight of a sack.

The spectrum of w/c ratios tested ranged from a minimum of 0.37 to a maximum of 0.47, encompassing a diverse set of proportions to comprehensively analyze the effects on the mixture and its subsequent properties. The approach involved incrementally altering the cementitious content, allowing for a thorough investigation of how different w/c ratios influence the characteristics and performance of the resulting material. These are not the only ranges possible but these are a useful range to show how the w/c impacts the results.

This evaluation aims to shed light on the optimal w/c ratio that aligns with the desired ability to 3D print concrete as well as the necessary concrete properties and standards. All results were plotted on the Tarantula Curve. This is a tool that is used to better understand the aggregate distribution and packing and how these parameters impact the flowability of the concrete mixture. Previous Tarantula Curves have been used for flowable concrete or for slip formed concrete but not to guide the design of 3D printed concrete.

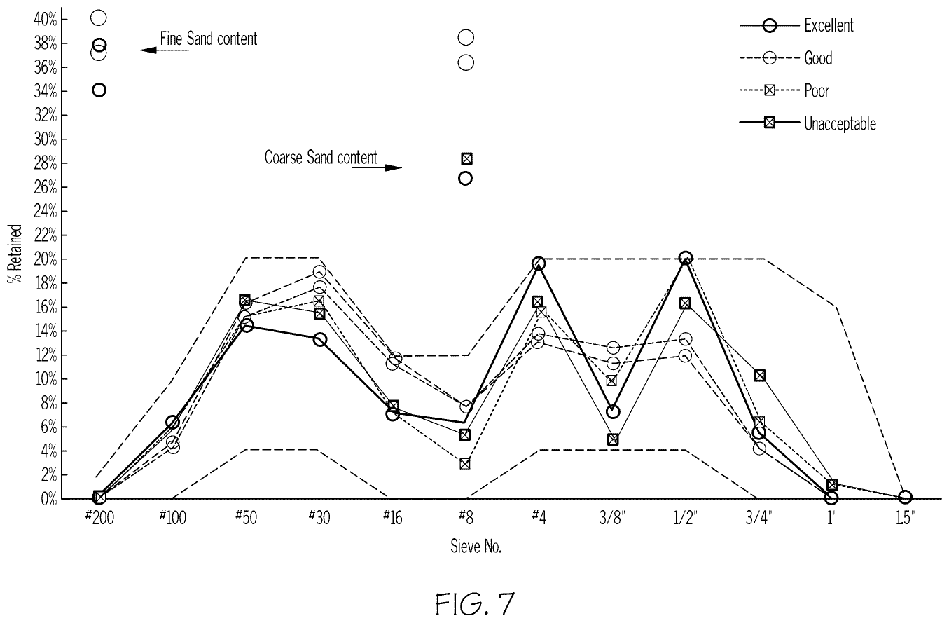

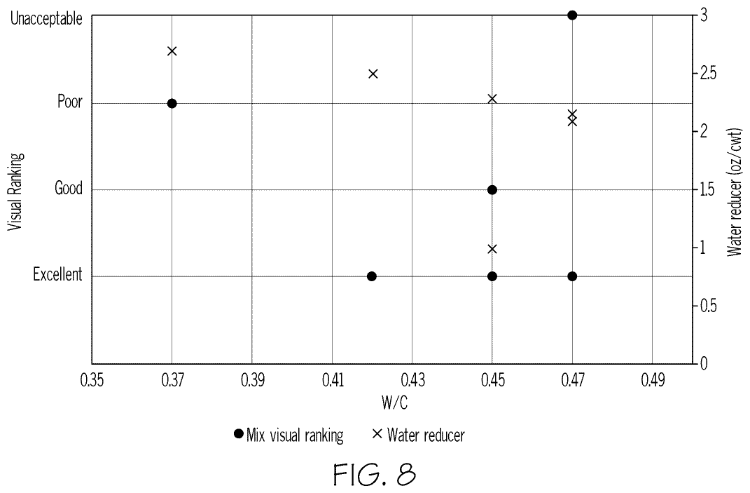

The mixture design and specifications of each mix can be seen in Table 6. Moreover, FIG. 7 shows the Tarantula Curve for all mixes. Excellent print is shown in Dark O, good with light O, poor in light X, and unacceptable in dark X.

TABLE 6

| MIX | | Batch | Paste | | | | Fly | Coarse | Coarse | | | | Water | Citric |
|---|---|---|---|---|---|---|---|---|---|---|---|---|---|---|
| No. | | size | content | W/C | Slump | Cement | Ash | I | II | Fine | Water | Nanoclay | reducer | acid |
| Units | Date | cf | % | — | in | lb/cy | lb/cy | lb/cy | lb/cy | lb/cy | lb/cy | g/cy | g/cy | g/cy |
| Mix #3 | Jul. 22, 2022 | 6 | 28 | 0.37 | 4.5 | 526 | 132 | 1232.4 | 426 | 1387 | 244.4 | 6635.6 | 3138.4 | 746.16 |
| Mix #4 | Aug. 1, 2022 | 8 | 27 | 0.42 | 4.75 | 489 | 122 | 1275 | 500 | 1425 | 257 | 6161.7 | 2915.4 | 692.86 |
| Mix #5 | Aug. 2, 2022 | 7 | 26 | 0.45 | 5 | 451 | 113 | 1290 | 520 | 1445 | 253.8 | 5687.7 | 2690.0 | 639.57 |
| Mix #6 | Aug. 23, 2022 | 3 | 25 | 0.47 | 4 | 414 | 103 | 1150 | 600 | 1550 | 243 | 5213.7 | 2466 | 639.57 |
| Mix #7-1 | Aug. 30, 2022 | 7 | 25 | 0.47 | 4.75 | 414 | 103 | 1500 | 500 | 1325 | 243 | 5213.7 | 2465.9 | 639.57 |
| Mix #8-2 | Oct. 17, 2022 | 3.5 | 26 | 0.45 | 5 | 451 | 113 | 1680 | 60 | 1505 | 254 | 5687.7 | 0 | 639.57 |
| Mix #8-3 | Oct. 17, 2022 | 3.5 | 26 | 0.45 | 4.5 | 451 | 103 | 1515 | 70 | 1650 | 254 | 5687.7 | 1175.4 | 639.57 |

A summary of the Tarantula Curves is shown in FIG. 7. As can be seen from the figure, the gradations are almost the exact same value. This is done so that the results can be compared as the w/c ratios and paste volumes are changed.

FIG. 8 illustrates the visual ranking of mixes for different w/c ratios. The left side y-axis indicates the visual ranking, while the right side y-axis shows the dosage of the used water reducer. As can be seen, increasing the water to cement ratio decreases the water reducer dosage. Based, a 0.45 w/c ratio, with a paste content of 26%, and a water reducer dosage of 2.0±0.5 oz/cwt, was used for subsequent evaluations.

### B. Fine Sand Content

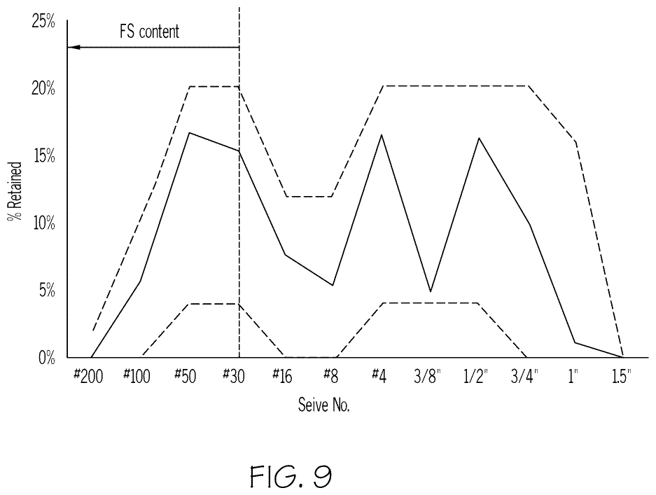

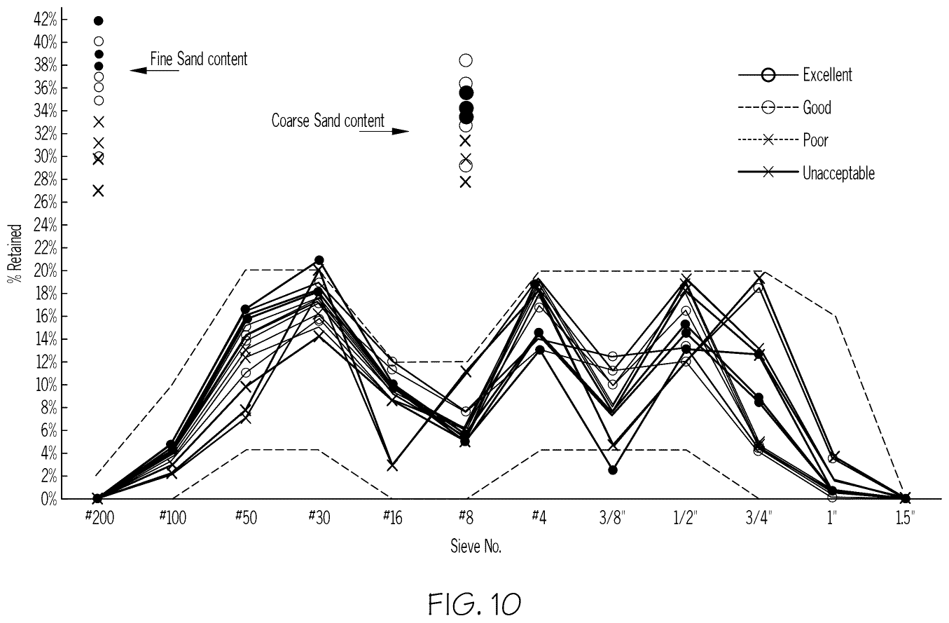

Another parameter is the fine sand content within the mixture. The determination of fine sand content is tied to aggregate gradation, offering insights into the amount of fine aggregate that is retained on the #30 to the #200 sieve. This is shown in Table 7 and in FIG. 9.

TABLE 7

| Sieve | Course I | Coarse II | Fine I | Combined |
|---|---|---|---|---|
| Number | (%) | (%) | (%) | % Retained |
| 1.5″ | 0.00 | 0.00 | 0.00 | 0.00 |
| 1″ | 2.95 | 0.00 | 0.00 | 1.15 |
| ¾″ | 26.06 | 0.61 | 0.00 | 10.22 |
| ½″ | 41.78 | 0.34 | 0.00 | 16.28 |
| ⅜″ | 10.25 | 6.21 | 0.00 | 4.94 |
| #4 | 13.60 | 69.91 | 1.05 | 16.53 |
| #8 | 2.92 | 13.10 | 4.83 | 5.36 |
| #16 | 0.70 | 4.39 | 14.59 | 7.63 |
| #30 | 0.29 | 2.42 | 32.72 | 15.45 |
| #50 | 0.73 | 1.65 | 35.07 | 16.58 |
| #100 | 0.48 | 0.95 | 11.74 | 5.70 |
| #200 | 0.24 | 0.42 | 0.00 | 0.16 |

These fine materials play a role in how the aggregates pack. This aggregate packing is important for the cohesion, flow, and finish of the mixture. The effect of fine sand (FS) content was investigated in order to determine how different FS values impact the 3D Print characteristics. All mixes were done using w/c=0.45. The FS content versus Visual Ranking was investigated. The minimum FS investigated was 27%, and the maximum FS was 42%. The mixture design and specifications of each mix can be seen in Table 8.

TABLE 8

| | FS content | Cement | Fly Ash | Coarse I | Coarse II | Fine | Water | Nano Clay | Water Reducer | Citric acid |
|---|---|---|---|---|---|---|---|---|---|---|
| No. | % | lb/cy | lb/cy | lb/cy | lb/cy | lb/cy | lb/cy | g/cy | g/cy | g/cy |
| 10 | 27 | 451 | 113 | 1480 | 630 | 1130 | 253.8 | 5687.69 | 1739.5 | 639.57 |
| 11 | 30 | 451 | 113 | 1400 | 580 | 1270 | 253.8 | 5687.69 | 3562.4 | 639.57 |
| 12 | 30 | 451 | 113 | 1290 | 650 | 1308 | 253.8 | 5687.69 | 1429.85 | 639.57 |
| 13 | 31 | 451 | 113 | 1340 | 565 | 1341 | 253.8 | 5687.69 | 314.08 | 639.57 |
| 14 | 33 | 451 | 113 | 1200 | 635 | 1408 | 253.8 | 5687.69 | 1077.3 | 639.57 |
| 15 | 35 | 451 | 113 | 1122 | 615 | 1516.5 | 253.8 | 5687.69 | 1165.05 | 639.57 |
| 16 | 36 | 451 | 113 | 1180 | 495 | 1560 | 253.8 | 5687.69 | 831.06 | 639.57 |
| 17 | 38 | 451 | 113 | 1260 | 510 | 1470 | 253.8 | 5687.69 | 1528.35 | 639.57 |
| 18 | 38 | 451 | 113 | 1170 | 405 | 1657 | 253.8 | 5687.69 | 2256.32 | 639.57 |
| 19 | 39 | 451 | 113 | 1108 | 420 | 1700 | 253.8 | 5687.69 | 1953.32 | 639.57 |
| 20 | 40 | 451 | 113 | 1026 | 598 | 1607 | 253.8 | 5687.69 | 1830.33 | 639.57 |
| 21 | 42 | 451 | 113 | 950 | 540 | 1735 | 253.8 | 5687.69 | 1326.15 | 639.57 |
| 22 | 44 | 451 | 113 | 923 | 530 | 1770 | 253.8 | 5687.69 | 2191.32 | 639.57 |
| 23 | 45 | 451 | 113 | 1300 | 95 | 1830 | 253.8 | 5687.69 | 2856.67 | 639.57 |
| 24 | 48 | 451 | 113 | 797 | 520 | 1900 | 253.8 | 5687.69 | 1867.77 | 639.57 |
| 25 | 52 | 451 | 113 | 700 | 450 | 2060 | 253.8 | 5687.69 | 2244.33 | 639.57 |
| 26 | 55 | 451 | 113 | 880 | 100 | 2225 | 253.8 | 5687.69 | 2335.15 | 639.57 |
| 27 | 56 | 451 | 113 | 710 | 246 | 2245 | 253.8 | 5687.69 | 2255.76 | 639.57 |
| 28 | 60 | 451 | 113 | 590 | 195 | 2409 | 253.8 | 5687.69 | 2252.25 | 639.57 |

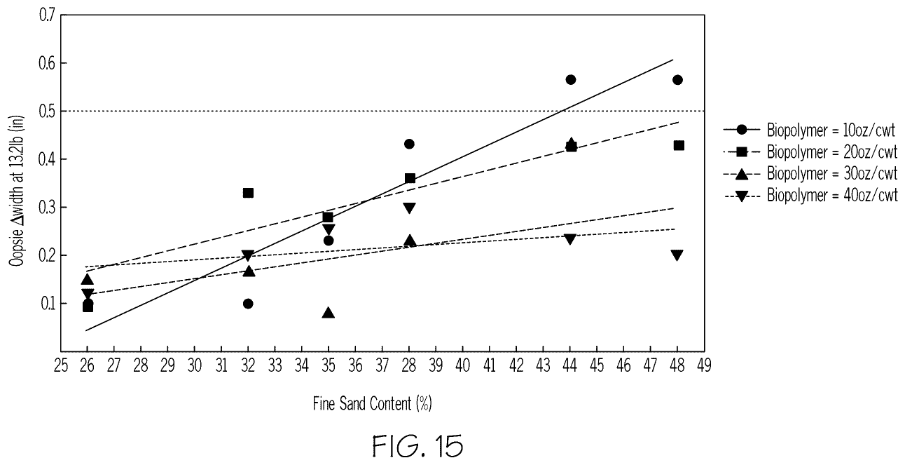

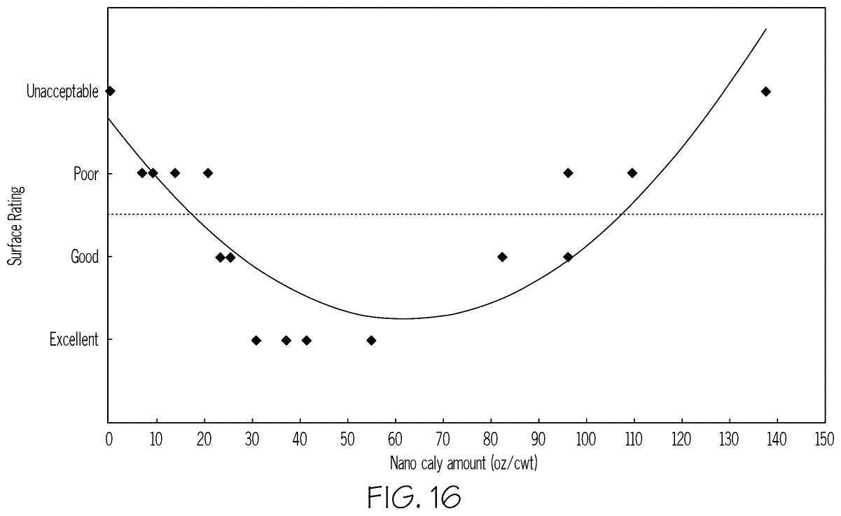

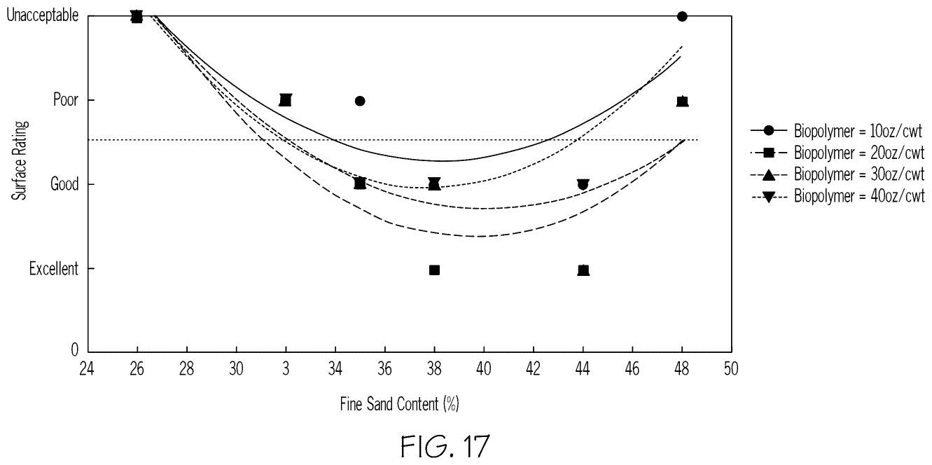

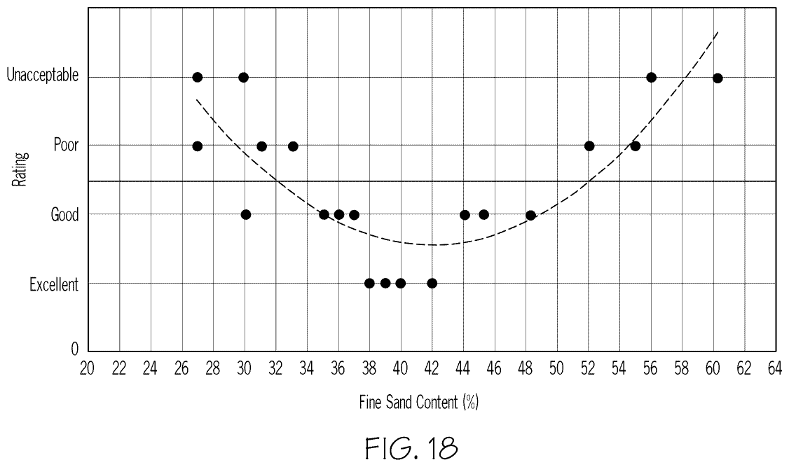

A summary of the Tarantula Curves for the investigated mixtures is shown in FIG. 8. When the FS content was above 34%, there is improved performance over mixtures with FS contents below this value. The combined gradation of the aggregates were within the boundaries of the Tarantula Curve from the #16 to the 1.5″. Additional data related to fine sand content with biopolymer (polysaccharide) based sticky additives are shown in FIGS. 15-19.

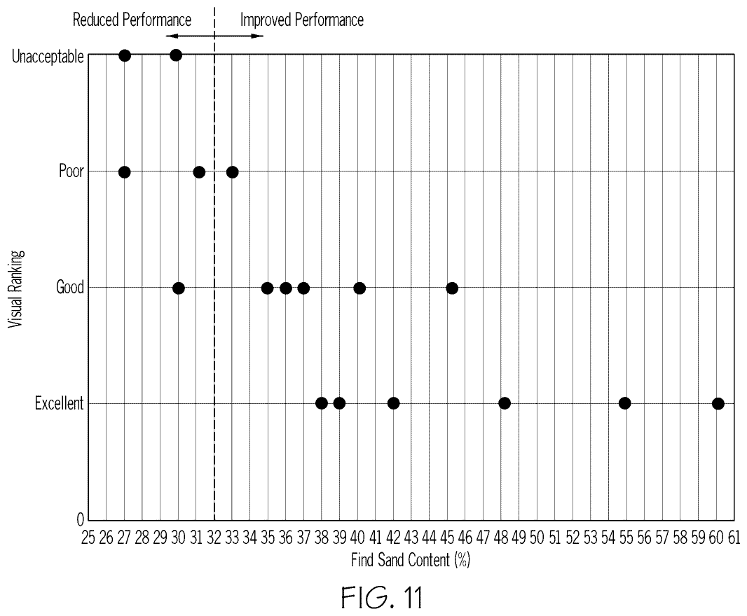

A summary of the test results is shown in FIG. 11. This graph shows that as the FS content increased, the performance of the mixture improved for the mixture. It would be expected that as the FS content continued to increase then the visual rating would decline.

### C. Nanoclay and Citric Acid

In order to investigate the effect of nanoclay and citric acid in the mixture, different mixes were made and examined for print quality and other tests mentioned above. In total, 6 mixes with different percentages of nanoclay and citric acid were produced.

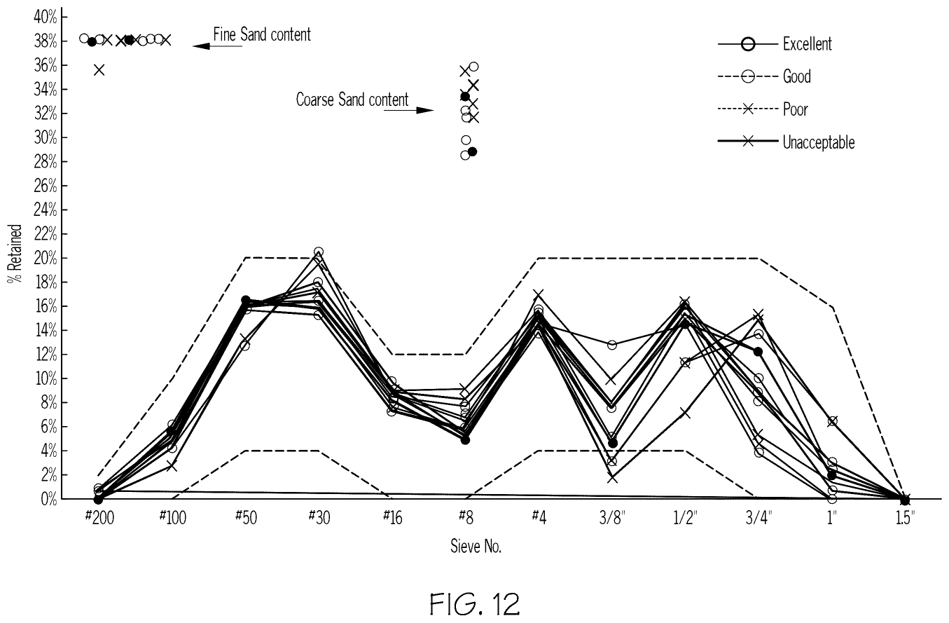

The mixtures investigated are shown in Table 9. A Tarantula Curve is also shown in FIG. 12. For all the mixtures investigated the w/c, water reducer dosage, and aggregate gradations were similar. The difference in performance is primarily caused by the different dosages of nanoclay and citric acid.

TABLE 9

| | FS | | Fly | Coarse | Coarse | | | | | Water | |
|---|---|---|---|---|---|---|---|---|---|---|---|
| | content | Cement | Ash | I | II | Fine | Water | Nanoclay | | Reducer | Citric acid |
| No. | % | lb/cy | lb/cy | lb/cy | lb/cy | lb/cy | lb/cy | g/cy | | g/cy | g/cy |
| Mix 14-1 | 38.01 | 451 | 113 | 1170 | 405 | 1657 | 253.8 | 5687.69 | | 2254 | 639.57 |
| Mix 16-1 | 38.0 | 451 | 113 | 1110 | 565 | 1560 | 253.8 | 2843.8 | (50%) | 1012.5 | 639.57 |
| Mix 16-2 | 38.0 | 451 | 113 | 1110 | 565 | 1560 | 253.8 | 1895.9 | (33%) | 1031.13 | 639.57 |
| Mix 17-1 | 38.05 | 451 | 113 | 1250 | 432 | 1555 | 253.8 | 1421.9 | (25%) | 299.9 | 639.57 |
| Mix 18-1 | 35.65 | 451 | 113 | 1340 | 400 | 1500 | 253.8 | 2843.8 | (50%) | 1084.8 | 319.8 (50%) |
| Mix 18-2 | 35.65 | 451 | 113 | 1340 | 400 | 1500 | 253.8 | 1421.9 | (25%) | 1148.4 | 159.9 (25%) |
| Mix 33-1 | 38.0 | 451 | 113 | 995 | 650 | 1587 | 253.8 | 0.0 | (0%) | 1159.2 | 639.57 |
| Mix 23-1 | 38.11 | 451 | 113 | 1267 | 410 | 1560 | 253.8 | 4265.76 | (75%) | 1985.4 | 639.57 |
| Mix 25-1 | 38.0 | 451 | 113 | 1542 | 210 | 1490 | 253.8 | 4834.53 | (85%) | 1631.16 | 639.57 |
| Mix 27 | 38.16 | 451 | 113 | 1400 | 370 | 1470 | 253.8 | 5232.65 | (92%) | 1481.67 | 639.57 |
| Mix 28-1 | 38.20 | 451 | 113 | 1211 | 485 | 1540 | 253.8 | 6370.19 | (112%) | 634.5 | 639.57 |
| Mix 25-2 | 38.0 | 451 | 113 | 1542 | 210 | 1490 | 253.8 | 7109.61 | (125%) | 2260.98 | 639.57 |
| Mix 28-2 | 38.20 | 451 | 113 | 1211 | 485 | 1540 | 253.8 | 7678.38 | (135%) | 1416.78 | 639.57 |
| Mix 23-2 | 38.11 | 451 | 113 | 1267 | 410 | 1560 | 253.8 | 8531.53 | (150%) | 2493.99 | 639.57 |
| Mix 30-1 | 38.14 | 451 | 113 | 1235 | 450 | 1550 | 253.8 | 11375.38 | (200%) | 2946.6 | 639.57 |
| Mix 30-2 | 38.14 | 451 | 113 | 1235 | 450 | 1550 | 253.8 | 17063.07 | (300%) | 2860.2 | 639.57 |
| Mix 33-2 | 38.0 | 451 | 113 | 995 | 650 | 1587 | 253.8 | 19906.9 | (350%) | 2614.32 | 639.57 |
| Mix 31-1 | 38.06 | 451 | 113 | 980 | 670 | 1583 | 253.8 | 22750.76 | (400%) | 5633.1 | 639.57 |
| Mix 31-2 | 38.06 | 451 | 113 | 980 | 670 | 1583 | 253.8 | 28438.45 | (500%) | 6260.4 | 639.57 |

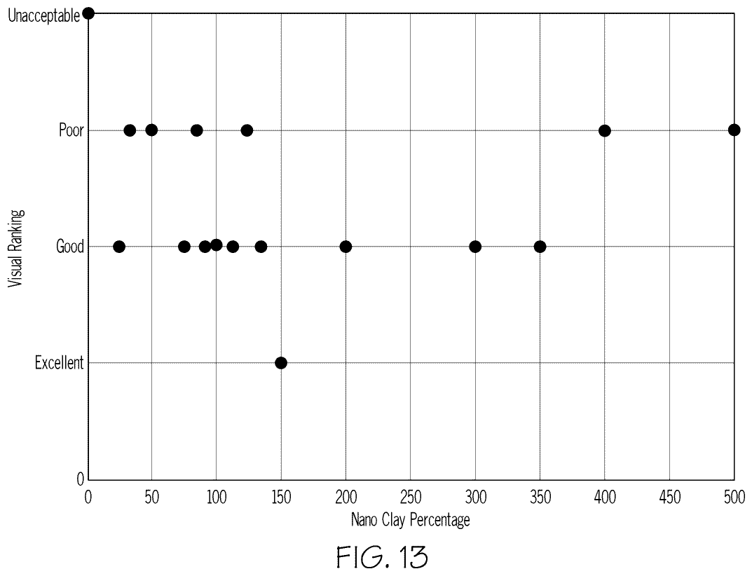

FIG. 13 shows the percentage of nanoclay on the x-axis versus the print quality on the y-axis. Each dot represents a different mix. The optimal quantity of nanoclay is defined as 100%. This 100% nanoclay, which is 5687.69 g/cy. Similarly, the same principle applies to citric acid. The 100% citric acid represents the ideal amount chosen for use in the mixture design, which is 639.57 g/cy. The percentages displayed above the data points show the percentage of nanoclay and citric acid, respectively. The mix with the 100% amount of designed nanoclay showed excellent quality. Having 50% and lower percentages of designed nanoclay, pulls the print quality toward Poor or Unacceptable. Data showing comparisons to the nanoclay and the biopolymer (polysaccharide) are included in FIGS. 15-19.

### D. Change in Oopsie Test

The Oopsie test aims to validate the print quality and the ability to stack concrete mixtures. The method has several advantages: (1) Fast: the process takes less then 10 minutes and can be completed on fresh concrete. This allows for rapid feedback on the performance of the concrete; (2) Ease of Use: The method is designed to be straightforward and user-friendly, requiring minimal training and enabling efficient implementation; (3) Low Equipment Requirements: The process demands only basic equipment, minimizing investment and operational costs while maximizing accessibility.

Concrete is poured into a 4″×8″ cylinder mold with no bottom and compacted in two layers. Each layer is rodded 25 times and then the sides are taped. A trowel is either placed under the cylinder as it is being filled or forced under the concrete after it has been consolidated. Next, the cylinder is placed in a horizontal position, and a plunger that fits within the 4″×8″ cylinder is used to force the wet concrete out of the mold. Measurements of the width and height of the formed wet concrete are taken at 2″ from the front and back edge of the concrete cylinder.

The process should be repeated to put another layer on top of the existing layer. Adding a second layer applies some pressure on the first layer. Thereby, the first layer's dimension changes, simulating printing a layer on the existing one in the field. Steel plates of known weights are then placed on top of the cylinder. After reviewing data, it was observed that a parameter relative to the performance was with respect to when 13.2 lbs. of load was placed on the concrete. This allowed the performance of the sticky additive to be evaluated. If the sticky additive was successful, then the change in deformation would be in some aspects less than 0.5 inches. If this was not the case, then the deformation would be larger. As stated above, the effectiveness of the sticky additive is also dependent on the amount of fine sand that is in the mixture (see, e.g., FIGS. 15, 17, and 18-19).

By adding layers, the dimension changes in the bottom layer are measured. Low changes in the diameter of the bottom layer show that the concrete has high cohesion. This means it will be able to hold load and show superior performance in 3D printing. The surface of the concrete after it is extruded also gives insight to the surface finish that is expected on the printed wall.

The change in the shape of the Oopsie test is used to evaluate the performance of the concrete mixture. The numerical difference in the change in width and height can be used to give a numerical quantification of the cohesion of the mixture. This measurement gives insight into the Poisson's ratio (the classical definition v=transverse strain/axial strain but for this application v=transverse strain/strain in the direction of the load) of the fresh concrete. This number needs to be low to ensure that the concrete has minimal transverse deformation as the load is placed on the surface.

While these tests used steel plates of known weights, different weights or materials could be used to load the fresh concrete. A platform may be placed on the first layer and then weights could be placed and the dimension of the underlying concrete could be measured.

Different mix with different fine sand content has been used to measure the Oopsie change. Table 10 shows the amounts of FS, visual rankings, change in oopsie for both the front and back sides and their average in the last column.

TABLE 10

| | | | | Difference in Oopsie (in) | | |
|---|---|---|---|---|---|---|
| Mix # | w/c | FS (%) | Visual Ranking | Front | Back | Average |
| #12-1 | 0.45 | 33.02 | Poor | 0 | 0.2 | 0.1 |
| #14-1 | 0.45 | 38.01 | Excellent | 0.1 | 0.1 | 0.1 |
| #8-3 | 0.45 | 40.13 | Good | 0 | 0.2 | 0.1 |
| #11-2 | 0.45 | 27.01 | Poor | 0.2 | 0.1 | 0.15 |
| #14-2 | 0.45 | 39.01 | Excellent | 0.1 | 0.3 | 0.2 |
| #15-1 | 0.45 | 36.07 | Good | 0.1 | 0.4 | 0.25 |
| #21 | 0.45 | 42 | Excellent | 0.3 | 0.2 | 0.25 |
| #15-2 | 0.45 | 31.13 | Poor | 0.2 | 0.5 | 0.35 |
| #8-2 | 0.45 | 37.01 | Good | 0 | 0.7 | 0.35 |
| #12-2 | 0.45 | 35.02 | Good | 0.5 | 0.3 | 0.4 |
| #13-2 | 0.45 | 30.06 | Good | 0.5 | 0.6 | 0.55 |

| | | | | | |
|---|---|---|---|---|---|
| #13-1 | 0.45 | 27 | Unacceptable | Failed | — |
| #11-1 | 0.45 | 29.9 | Unacceptable | Failed | — |

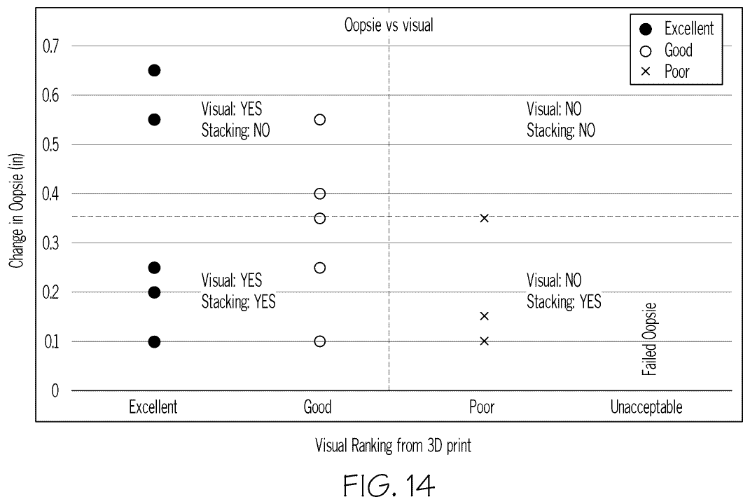

FIG. 14 shows the graph of Visual ranking vs Change in Oopsie test. This graph is useful as it quantifies the ability to print a concrete layer and create a smooth finish with the visual ranking on the X axis and the Y axis quantifies the ability to stack the layers without deformation. The results showed that there is a chance for the second layer to stack on top of the existing layer if the average change in Oopsie is 0.35 in or lower. Thereby, a second layer can be applied on top of the first layer as long as the average change in Oopsie is less than 0.35 in. However, stacking ability does not guarantee the visual ranking of the print, as can be seen on the right-down part of the figure that there is stacking ability with a Poor or Unacceptable print.

Dashed lines have been added to the graph to break it up into four quadrants. The mixture in the lower left are the only ones with both good stacking and finishing. The mixes in the other quadrants either have poor finishing, poor stacking, or both and they are not as desirable as the mixtures in the lower left quadrant. This information can be used to design concrete mixtures to have satisfactory performance.

Features and advantages of this disclosure are apparent from the detailed specification, and the claims cover all such features and advantages. Numerous variations will occur to those skilled in the art, and any variations equivalent to those described in this disclosure fall within the scope of this disclosure. Those skilled in the art will appreciate that the conception upon which this disclosure is based may be used as a basis for designing other compositions and methods for carrying out the several purposes of this disclosure. As a result, the claims should not be considered as limited by the description or examples.

What is claimed is:

1. A concrete formulation comprising:
a) a hydraulic component having a cementitious base material;
b) an aggregate component comprising:
i) coarse aggregates having a nominal maximum aggregate size of greater than 12.5 mm;
ii) optionally, intermediate aggregates having a nominal maximum aggregate size of 4.75-12.5 mm;
iii) fine sand aggregates having a nominal maximum aggregate size of 4.75 mm or less;
c) an admixture component comprising:
i) a sticky additive;
ii) optionally, a weak acid; and
iii) optionally, a water reducer or a blend of water reducers.

2. The concrete formulation of claim 1, wherein the hydraulic component is a Portland cement, calcium sulfoaluminate cement, a geopolymer, a calcium aluminate cement, a Portland limestone cement, or a blended Portland cement.

3. The concrete formulation of claim 1, wherein the sticky additive comprises a nanoclay, a biopolymer, or a combination thereof.

4. The concrete formulation of claim 1, wherein the nanoclay is derived from a layer silicate, a chain silicate, a sesquioxide, or a carbonate- or sulfate-based clay.

5. The concrete formulation of claim 4, wherein the nanoclay has an average particle diameter of 10-100 nm.

6. The concrete formulation of claim 4, wherein the biopolymer is a protein, collagen, actin, fibrin, a polyhydroxyalkanoate, polylactic acid (PLA), polyglycolic acid (PLGA), polycaprolactone, a polysaccharide, a cellulose ether, welan gum, xanthan gum, diutan gum, starch, a starch-based gum, chitosan, methyl cellulose, hydroxypropyl cellulose, alginate, an exopolysaccharide, a microbial polysaccharide, a marine gum, a plant exudate, a seed gum. a biopolymer present in a bacterial cell wall, a bacterial peptidoglycan, biopolymer S-657, or a combination thereof.

7. The concrete formulation of claim 1, comprising 10-50 ounces of the sticky additive per hundred lbs. of the hydraulic component.

8. The concrete formulation of claim 1, which comprises the weak acid, wherein the weak acid is formic acid, acetic acid, benzoic acid, phosphoric acid, sulfurous acid, citric acid, or a combination thereof.

9. The concrete formulation of claim 1, which comprises the weak acid, wherein the mass weight ratio of the weak acid to the sticky additive is 1:5 to 1:15 (weak acid:sticky additive).

10. The concrete formulation of claim 1, wherein the hydraulic component further comprises a supplementary cementitious material.

11. The concrete formulation of claim 1, comprising 1-25 ounces of the water reducer per hundred lbs. of the sum of the hydraulic and aggregate components.

12. The concrete formulation of claim 1, comprising at least 30% fine sand aggregates by volume of the aggregate components.

13. The concrete formulation of claim 1, wherein the sticky additive and fine sand aggregates are present in an amount sufficient to result in a change in width of 0.5 inches or less when 13.2 lbs. of weight are placed on a surface of a 3D printed structure formed from the concrete formulation.

14. A method of creating a concrete member, the method comprising:
a) positioning a plurality of reinforcement members in a travel path of a concrete member creating device;
b) moving the concrete member creating device along the travel path past the plurality of reinforcement members;
c) delivering a first cementitious mixture into a space defined by the concrete member creating device through a side of the concrete member creating device as the concrete member creating device moves along the travel path, wherein the first cementitious mixture is formed from water and the concrete formulation of claim 1; and
d) pressurizing the first cementitious mixture within the concrete member creating device as the concrete member creating device is moved to create a first layer of the concrete member.

15. The method of claim 14, further comprising:
a) lifting the concrete member creating device after the concrete member creating device has traveled a desired distance along the travel path to create the first layer of the concrete member;
b) returning the concrete member creating device to a desired location along the travel path; and
c) moving the concrete member creating device above the first layer of the concrete member and along the travel path past the plurality of reinforcement members;
d) delivering a second cementitious mixture into a space defined by the concrete member creating device through a side of the concrete member creating device as the concrete member creating device moves along the travel path, wherein the second cementitious mixture is formed from water and the concrete formulation of claim 1; and
e) pressurizing the second cementitious mixture within the concrete member creating device as the concrete member creating device is moved above the first layer of the concrete member to create a second layer of the concrete member atop the first layer of the concrete member.

16. The method of claim 15, further comprising;
a) lifting the concrete member creating device after the concrete member creating device has traveled the desired distance along the travel path to create the second layer of the concrete member;
b) returning the concrete member creating device to a desired location along the travel path; and
c) repeating the moving the concrete member creating device step, the delivering step, the pressurizing step, the lifting step, and the returning step above the second layer of the concrete member a desired number of times to create additional layers of the concrete member atop the first and second layers until the concrete member has reached a desired height.

17. The method of claim 14, wherein the concrete member creating device comprises:
a) a first side plate through which the cementitious mix is delivered; and
b) a second plate spaced from the first side plate.

18. The method of claim 17, further comprising moving the first and second plates with a single transport unit.

19. The method of claim 17, further comprising moving the first and second side plates in a synchronous manner with first and second transport units respectively.

20. The method of claim 14, wherein the ratio of water to the concrete formulation of claim 1 is 0.35-0.5.
